(19) United States
(12) Patent Application Publication
(10) Pub. No.: US 2024/0370750 A1
(43) Pub. Date: Nov. 7, 2024

(54) REINFORCEMENT LEARNING USING LIFTED ACTION MODELS

(71) Applicant: INTERNATIONAL BUSINESS MACHINES CORPORATION, Armonk, NY (US)

(72) Inventors: Harsha Kokel, Milpitas, CA (US); Michael Katz, Goldens Bridge, NY (US); Junkyu Lee, San Diego, CA (US); Shirin Sohrabi Araghi, Briarcliff Manor, NY (US)

(21) Appl. No.: 18/313,310

(22) Filed: May 5, 2023

(51) Int. Cl. G06N 7/01; G06N 20/00

(52) U.S. Cl. CPC G06N 7/01; G06N 20/00

(57) ABSTRACT

A computer-implemented method for generating a policy for performing a goal and including a plurality of intra-option policies includes the following operations. A planning domain including lifted action models is received. A Markov Decision Process (MDP) distribution is received. A mapping function between MDP states of a MDP within the MDP distribution and planning states of the planning domain is generated. Using the mapping function, a parameterized option for each of the lifted action models is defined. Using reinforcement learning, an intra-option policy for each of the parameterized options is trained.

### BACKGROUND

The present invention relates to machine learning, and more specifically, to integrate artificial intelligence (AI) planners and reinforcement learning (RL) though lifted action models.

Many types of machine learning technologies used to train an AI agent include supervised learning (SL), unsupervised learning (UL), and reinforcement learning (RL). RL differs from SL by not requiring labeled input/output pairs and not requiring sub-optimal actions to be explicitly corrected. FIG. 1A illustrates a typical RL architecture 100.

In describing RL, the following terms are oftentimes used. The “Agent” refers to software programs that make intelligent decisions, and the agents are the learners in RL. These agents interact with the environment by actions and receive rewards based upon those actions. The “Environment” refers to the real-world (or simulated) environment with which the agent interacts. The “State” Sₜ refers to a current situation/position of the agent. Each state Sₜ may have one or more dimensions that describe the state. The “Reward” Rₜ is feedback from the environment (also illustrated as “r” in FIG. 2B), which is used to evaluate actions Aₜ taken by the agent.

A reward function, which is part of the environment, generates the reward Rₜ, and the reward function reflects the desired goal of the model being trained. The “policy” 71 is a methodology by which to map the state Sₜ of the agent to a certain action Aₜ. Formally, the policy π(s) is defined as the suggested action (or a probability distribution of actions) that the agent should take for every possible state s∈S. In short, the policy π is the strategy employed by the agent in pursuit of the desired goal. The “value” is a future reward received by an agent by taking an action Aₜ in a particular state Sₜ. Ultimately, the goal of the agent is to generate actions Aₜ that maximize the reward function.

Markov Decision Process (MDP) is a standard model for sequential decision making under uncertainty and is frequently used as part of RL. A MDP can be defined as a tuple M=(S, A, R, T, T₀, γ, H) with S is a set of states, A is set of actions, R(rₜ₊₁|sₜ, aₜ, sₜ₊₁) is a reward function, T(sₜ₊₁|sₜ, aₜ) is a transition function, T₀(s₀) is an initial state distribution, γ is a discount factor, and H is the horizon. In a standard RL setting, a policy π is learned that maximizes some cumulative function of the random rewards, which is typically the expected discounted sum over a defined horizon.

Benefits of using RL including being able to easily handle low-level control signals and high-dimension inputs. Additionally, RL is a data-driven approach with no need to provide symbolic methods. One disadvantages of using RL is the high cost of maintaining the large amount of data used during RL. Additionally, many RL methods suffer from sample inefficiency. Moreover, the policy learned from RL may not be easily understood.

Conventional MDPs do not involve temporally extended courses of action over a broad time scale. Rather, primitive actions are based upon a single discrete time step (i.e., a unitary action taken at time t affects the state and reward at time t+1). Options O involve closed-looped policies πₒ for taking actions over an extended period of time. A set of options O for a MDP is a semi-Markov decision process (SMDP), which is used to model temporally-extended courses of action. An option O consists of three components:
an intra-option policy πₒ specific to the option: S×A→[0, 1],
a termination condition β₀: S⁺→[0, 1], and
an initiation set Iₒ ⊂ S.

An option (Iₒ, πₒ, β₀) is available in state sₜ if and only if sₜ ∈I. If the option O is taken, then a single primitive action (point action) or temporally extended actions are selected according to the intra-option policy πₒ until the option O terminates stochastically according to the termination condition βₒ. Advantageously, the initiation set Iₒ limits the need to define the intra-option policy πₒ only for those states where the option O may be taken (i.e., {s: βₒ(s)<}⊂ (Iₒ). In other words, the intra-option policy rrₒ for a particular option O need only be defined over the initiation set Iₒ rather than over all states S. When an option O terminates according to a termination condition βₒ, the agent has the opportunity select another option according to a policy Π.

Automated planning and scheduling, oftentimes referred to as AI planning, is a branch of artificial intelligence. AI planning is the task of finding a procedural course of action for a declaratively-described system to reach a defined goal while optimizing overall performance measures. Automated AI planners find the transformations (e.g., actions) to apply in each given state out of the possible transformations for that state. This sequence of actions (i.e., action sequences) is intended to transform the state of the world/environment, step by step, in a manner that satisfies the defined goal.

One of the benefits of using AI planning is that it is efficient for finding goal-directed action sequences. Additionally, AI planning is scalable through compact symbolic encoding of a state transition system using a plan. Additionally, the plans are natively explainable. One disadvantage of using AI planning is that it is difficult to obtain symbolic models. Additionally, AI planning performs poorly in handling perception-oriented inputs such as images.

Although AI planning and RL both solve decision-making problems, they take fundamentally different approaches in doing so. One approach to integrating AI planning and RL is Planning Annotated RL (PaRL). A typical PaRL architecture 200 is illustrated in FIG. 2. In the PaRL architecture 200, the AI planner acts as a higher-level control agent 210 and a Markov Decision Process (MDP) acts as a lower-level agent 220. The MDP 220 has a sensory/image representation of a state, and the AI planner 220 uses symbolic representations of the state. A state mapping function L exists that maps low-level states of the MDP 220 to a high-level state of the AI planner 220. Additionally, the AI planner 220 provides annotations for options. A PaRL task is defined by a triplet E=(M, Π, L), where
M is an MDP over states S,
Π is a planning task over states S′, and
L: S→S′ is a mapping from the states of the MDP to planning states.

The objective of the PaRL task is to find an optimal policy for the MDP M. Advantages of employing a PaRL architecture 200 is that it is scalable and sample efficient. Additionally, by using PaRL, plans or policies are easier to understand. In operation, the tasks are handled by the AI planner, and the low-level perceptions are handled by RL.

Although the use of PaRL has advantages over RL or an AI planner alone, PaRL still has limitations. Reference is made to the minigrids illustrated in FIGS. 3A-B. Minigrid is a library of discrete 2D grid-world environments with goal-oriented tasks that can be used to conduct research on RL. The agent is represented as a triangle, and tasks include solving different maze maps and interacting with different objects such as doors, keys, and/or boxes. The minigrid problem illustrated in FIG. 3B involves a 15×15 grid with 4 rooms. The goal of the task is to move the agent (i.e., the triangle) to the goal location, represented as the shaded box. This particular environment requires interaction with doors between the 4 rooms. Locked doors will require that the agent picks up keys associated with a particular locked door.

The PaRL framework 200 trained on the minigrid illustrated in FIG. 3A involves a pair of grounded actions (i.e., (pickup yellow-key room 3) and (pickup purple-key room 2) for which separate RL options are defined. For each of these grounded actions a separate policy is generated to learn these tasks. In this domain, the PaRL framework 200 is able to significantly improve sample efficiency. However, a limitation of the PaRL framework 200 is illustrated by attempting to use the agent previously-trained with the minigrid in FIG. 3A on the minigrid in FIG. 3B. In this instance, the agent is unable to achieve the defined goal, as a policy for the option of (pickup green-key room 3) was not defined, and consequently, the agent is not trained to perform the action. This illustrates a problem in adapting machine learning solutions to real world problems, which is that the real world oftentimes includes objects that were not seen during training. Accordingly, there is a need to generalize the agents trained using PaRL so as to allow these agents to handle different objects/problems/goals than what the agents were trained to handle.

### SUMMARY

A computer-implemented process for generating a policy for performing a goal and including a plurality of intra-option policies includes the following operations. An environment for a reinforcement learning architecture that includes a neural network as at least part of an agent is defined. A computer-implemented method for generating a policy for performing a goal and including a plurality of intra-option policies includes the following operations. A planning domain including lifted action models is received. A Markov Decision Process (MDP) distribution is received. A mapping function between MDP states of a MDP within the MDP distribution and planning states of the planning domain is generated. Using the mapping function, a parameterized option for each of the lifted action models is defined. Using reinforcement learning, an intra-option policy for each of the parameterized options is trained.

In other aspects of the process, a particular one of the parameterized options is defined as: an initiation set for the particular one of the parameterized options, one or more option parameters, a termination condition for the particular one of the parameterized options, and an intra-option policy for the particular one of the parameterized options. A replay buffer for the particular one of the parameterized options is initialized, and the training for the particular one of the parameter options includes storing, within the replay buffer and for a particular action from the intra-option policy for the particular one of the parameterized options, data including an initial state, the particular action, a reward, a subsequent state, and one or more values associated with the one or more option parameters. The intra-option policy for the particular one of the parameterized options is updated using the data. The MDP distribution defines an environment including a plurality of MDP meeting constraints, and the constraints including a predicate, action, object, type, and action model. The policy for performing the goal is configured to be used with a second MDP that meets the constraints. The mapping is generated using planning annotated reinforcement learning (PaRL). The planning domain includes a plurality of options for performing the goal.

A computer hardware system for generating a policy for performing a goal and including a plurality of intra-option policies includes a hardware processor configured to perform the following operations. A computer-implemented method for generating a policy for performing a goal and including a plurality of intra-option policies includes the following operations. A planning domain including lifted action models is received. A Markov Decision Process (MDP) distribution is received. A mapping function between MDP states of a MDP within the MDP distribution and planning states of the planning domain is generated. Using the mapping function, a parameterized option for each of the lifted action models is defined. Using reinforcement learning, an intra-option policy for each of the parameterized options is trained.

In other aspects of the hardware system, a particular one of the parameterized options is defined as: an initiation set for the particular one of the parameterized options, one or more option parameters, a termination condition for the particular one of the parameterized options, and an intra-option policy for the particular one of the parameterized options. A replay buffer for the particular one of the parameterized options is initialized, and the training for the particular one of the parameter options includes storing, within the replay buffer and for a particular action from the intra-option policy for the particular one of the parameterized options, data including an initial state, the particular action, a reward, a subsequent state, and one or more values associated with the one or more option parameters. The intra-option policy for the particular one of the parameterized options is updated using the data. The MDP distribution defines an environment including a plurality of MDP meeting constraints, and the constraints including a predicate, action, object, type, and action model. The policy for performing the goal is configured to be used with a second MDP that meets the constraints. The mapping is generated using planning annotated reinforcement learning (PaRL). The planning domain includes a plurality of options for performing the goal.

A computer program product includes a computer readable storage medium having stored therein program code for generating a policy for performing a goal and including a plurality of intra-option policies is disclosed. The program code, which when executed by computer hardware system, cause the computer hardware system to perform the following. A computer-implemented method for generating a policy for performing a goal and including a plurality of intra-option policies includes the following operations. A planning domain including lifted action models is received. A Markov Decision Process (MDP) distribution is received. A mapping function between MDP states of a MDP within the MDP distribution and planning states of the planning domain is generated. Using the mapping function, a parameterized option for each of the lifted action models is defined. Using reinforcement learning, an intra-option policy for each of the parameterized options is trained.

In other aspects of the computer program product, a particular one of the parameterized options is defined as: an initiation set for the particular one of the parameterized options, one or more option parameters, a termination condition for the particular one of the parameterized options, and an intra-option policy for the particular one of the parameterized options. A replay buffer for the particular one of the parameterized options is initialized, and the training for the particular one of the parameter options includes storing, within the replay buffer and for a particular action from the intra-option policy for the particular one of the parameterized options, data including an initial state, the particular action, a reward, a subsequent state, and one or more values associated with the one or more option parameters. The intra-option policy for the particular one of the parameterized options is updated using the data. The MDP distribution defines an environment including a plurality of MDP meeting constraints, and the constraints including a predicate, action, object, type, and action model. The policy for performing the goal is configured to be used with a second MDP that meets the constraints. The mapping is generated using planning annotated reinforcement learning (PaRL). The planning domain includes a plurality of options for performing the goal.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a flowchart of a typical reinforcement learning (RL) approach.

FIG. 2 illustrates a typical PaRL architecture.

FIGS. 3A-3B illustrate different minigrid states.

FIGS. 4A-4B illustrated a methodology for training a policy according to at least one embodiment of the present invention.

FIGS. 5A-5C respectively illustrate a grounded action model, a lifted action model, and a particular minigrid state.

FIG. 6 illustrates a domain distribution.

FIGS. 7A-7C respectively illustrate a lifted action model, a particular minigrid state, and a mapping function that maps the particular minigrid state to the lifted action model.

FIGS. 8A-8E illustrate comparative results from using PaRL, using modified PaRL according to at least one embodiment of the present invention to the aspects of the disclosed, and using standard RL.

FIG. 9 is a block diagram illustrating an example of computer environment for implementing the methodology of FIGS. 4A-4B.

### DETAILED DESCRIPTION

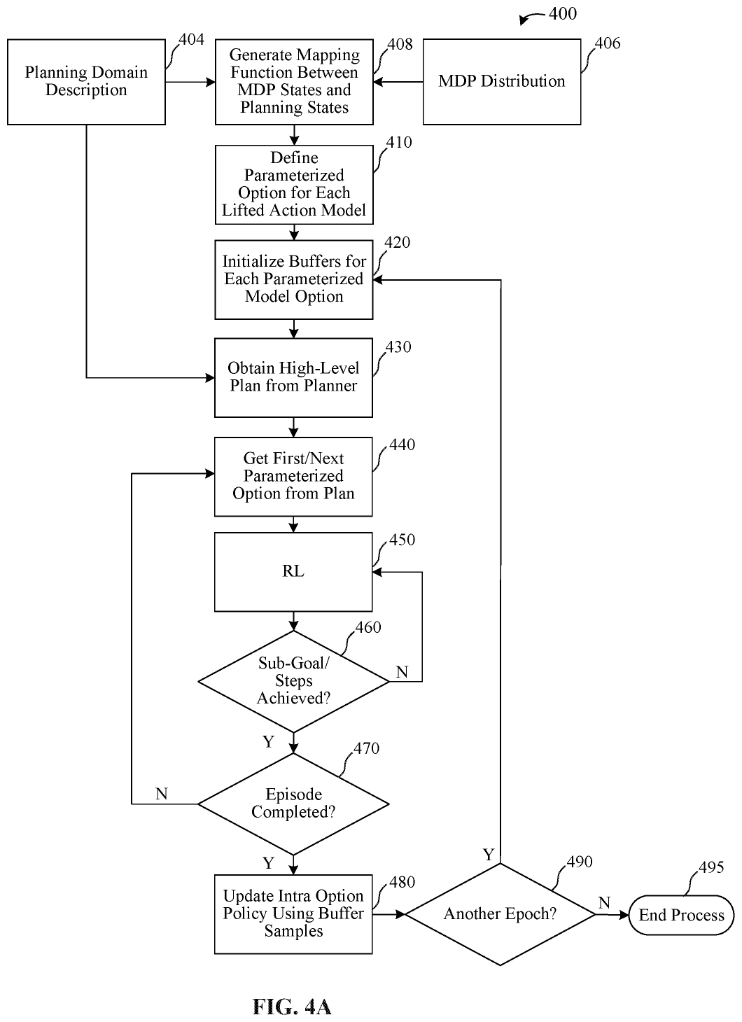

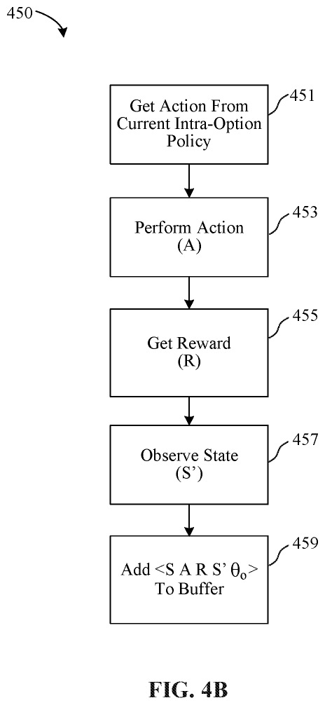

Referring to process 400 illustrated in FIGS. 4A-4B, a method of training a policy for performing a goal is disclosed. In 404, a planning domain is specified by a planner, and the manner in which the specification of the planning domain is received is not limited. Although not limited in this manner, a planner (i.e., planner software) is typically a domain-independent AI.

Known techniques used for representing planning domains include Stanford Research Institute Problem Solver (STRIPS), SAS+, and Planning Domain Definition Language (PDDL). Although not limited in this regard, in certain aspects, the process 400 employs PDDL to symbolically model the environment/world for which the policy is to be trained. A PDDL definition typically includes a domain file and a problem file. The domain file establishes the context of the world, which includes types (sets of things of interest in the world), predicates (facts about the objects of interest), and actions and/or options (i.e., ways of transitioning states of the world). The problem file includes objects (e.g., instances of the types), an initial state (e.g., the state of world at the beginning), and a specification of the goal (goal states of the world intended to be true).

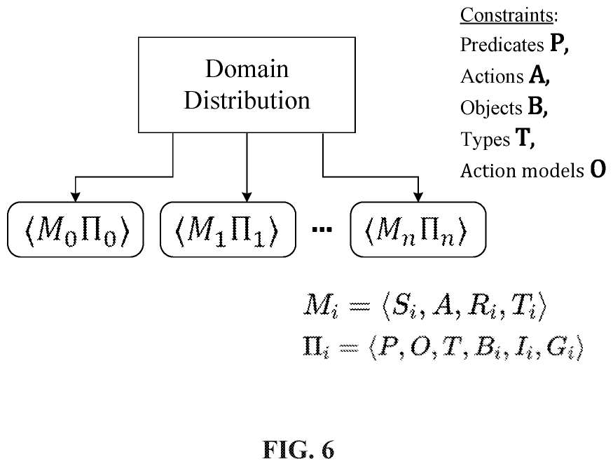

Actions are oftentimes described in planning domains using a grounded action model. An example of a grounded action model is illustrated in FIG. 6A. By way of example, this grounded action model refers to the minigrid model illustrated in FIG. 6C. The grounded action model describes a grounded action (i.e., “pickup_key1_room2”) and defines both preconditions and effects. For the particular grounded action to be applied to the particular state of the environment, the preconditions must be met. In the example illustrated, the preconditions are: key1 should be in room2, agent should be in room2, and agent must have empty hand. When these preconditions are met and the grounded action is performed (i.e., key1 is picked up by agent), the following effects occur: key1 is not in the room2, hand is not empty, and agent is carrying key1.

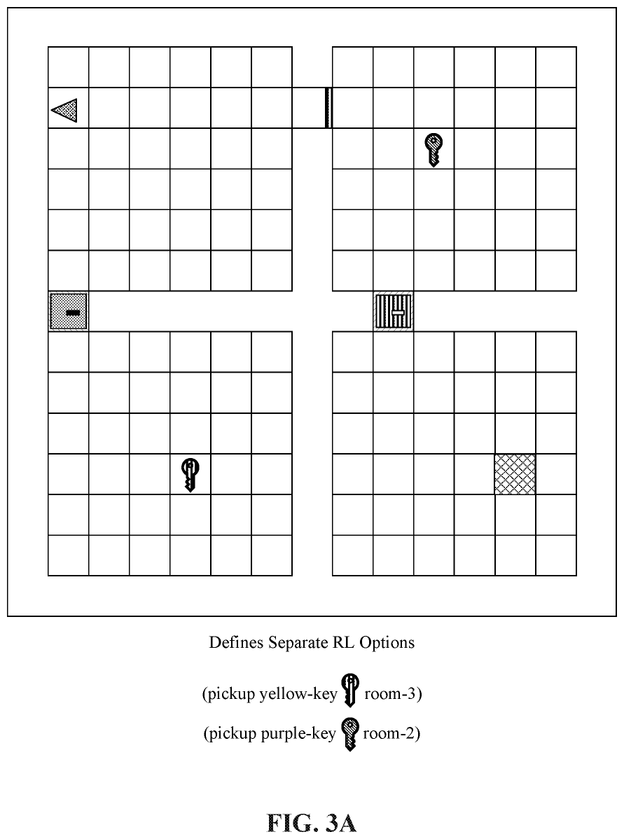

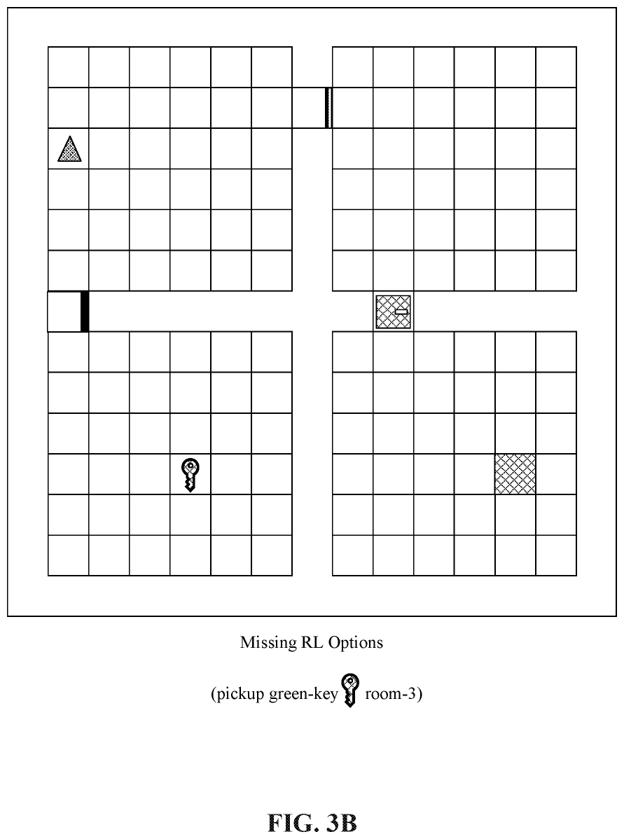

A problem associated with grounded action models can occur in environments that require multiple MDPs, which is typical of real-world environments. In this instance, the number of grounded action models required can be very large. For example, in the minigrid model, a separate grounded action model might be required for every combination of key and room. As discussed above with regard to the minigrids illustrated in FIGS. 3A, 3B. Although an agent was previously-trained to pick up a yellow key in room 3 and a green key in room 3, the agent was not trained to pick up a green key in room 3 (i.e., no policy was learned to perform this temporally-extended action).

Rather than using a grounded action model, which requires predefined options for each action, the present methodology 400 employs a Lifted Action Model (LAM) (also known as an action schema) as part of the planning domain description. In addition, the present methodology 400 defines a single parameterized option pₒ for a plurality of actions defined by the LAM. This parameterized option (pₒ=(Iₒ, θₒ, βₒ, πₒ)) can be defined as a tuple of:
an initiation set Iₒ ⊂ 2^{S},
parameters θₒ,
a termination condition βₒ: S×S×θₒ→[0, 1], and
an intra-option policy πₒ: S×θₒ→A.

More specifically, the initiation set Iₒ is the set of states where the lifted state L(s) satisfies the precondition of the action model, which is mathematically represented as

Iₒ={S|L(s) [symbol] preₒα,∃α,s∈S}.

Also, the termination condition βₒ is a logical combination of two conditions. The first condition is that the lifted state satisfies the effect and the second condition is the lifted state satisfies a frame condition. This is mathematically represented as:

$$\begin{matrix}{β}_{o} ( s , {s}^{′} , α ) = 1 if ( L ( {s}^{′} ) \text{\vert =} {eff}_{o} α ) and ( L ( {s}^{′} ) \text{\vert =} {F}_{o} ( α , s ) ) \\ = 0 otherwise .\end{matrix}$$

The frame condition Fₒ(α,s) is defined as the union of the context Cₒ(α,s) and the prevailing conditions, which is mathematically represented as:

$${F}_{o} ( α , s ) = {C}_{o} ( α , s ) ⋃ {prv}_{o} α$$

The context Cₒ(α,s) is defined as the set of facts with are part of the lifted state but not part of the preconditions or the effects, which is mathematically represented as:

$${C}_{o} ( α , s ) = L ( s ) ∖ \{ pr {e}_{o} α ⋃ {eff}_{o} α \}$$

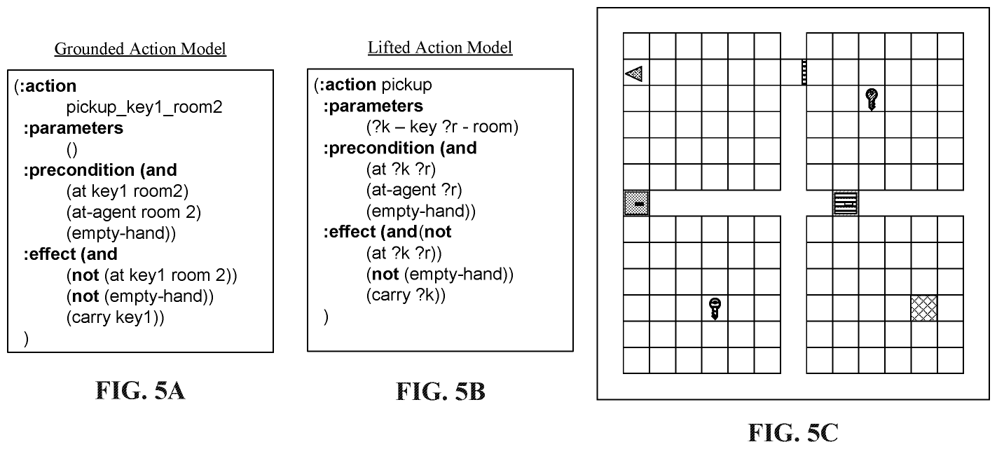

Notably, this differs from how an option O is typically defined in a planning domain description, which while including an initiation set Iₒ, a termination condition βₒ, and an in intra-option policy πₒ, does not include parameters θₒ. An example of a LAM is illustrated in FIG. 5B. A difference between a grounded action model of FIG. 5A and the LAM of FIG. 5B is that the parameters of a LAM can contain variables or lifted first-order predicates. In the example illustrated in FIG. 5B, the variables are indicated with the “?” prefix, and the “pickup” action has two variables: one for key and one for room. In this manner, a plurality of different grounded actions can be represented as single lifted action (e.g., “pickup”) defined by a single LAM.

In 406, a MDP distribution is identified and received. The MDP distribution is a generalized family of MDPs (Mₒ . . . Mₙ) with each having their own policy (Πₒ . . . Πₙ) within a same domain. Specifically, the domain is constrained to MDPs that have a predefined finite set of predicates (P), predefined finite possible actions A, finite objects B, finite types T, and all use the same action models O. Advantageously, methodology 400 can solve for a collection of MDPs so long as they adhere to these constraints. In this manner, a policy trained by one MDP Mₒ can be used with a second MDP Mₙ that also meets the constraints.

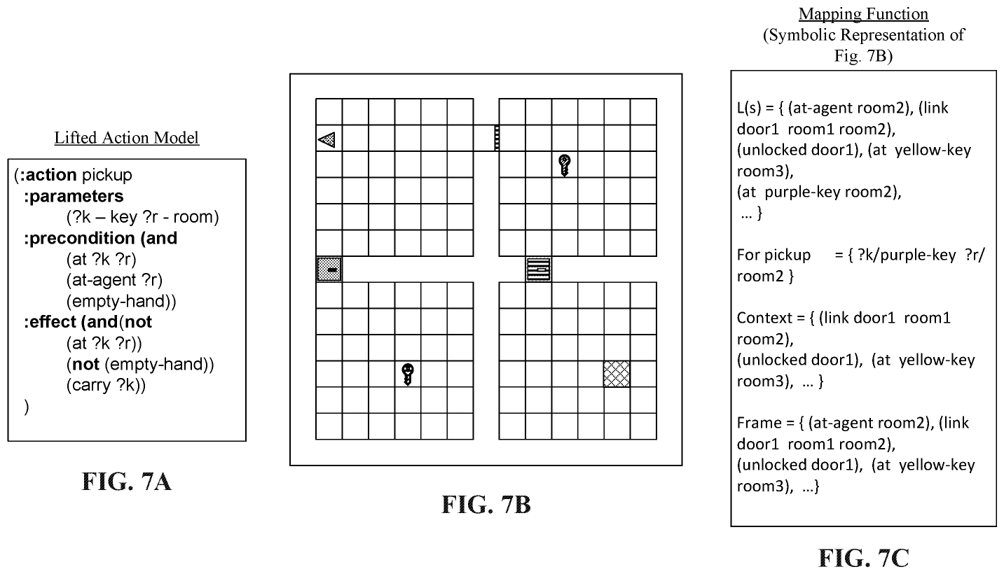

In 408, a mapping L is generated between the MDP states and planning states. Although not limited in this manner, the mapping L can be generated using the aforementioned PaRL approach. For example, FIG. 7C illustrates a lifted state L(s), which is a symbolic representation of the image illustrated in FIG. 7B. The mapping L is generated between an MDP state (e.g., the image of FIG. 7B) of a MDP within the MDP distribution and the planning state (i.e., the lifted action model of FIG. 7A). Since MDP states can be in a continuous state, the number of mappings L is not limited. In 410, parameterized options are defined for each lifted action model within the planning domain description, as discussed above.

For each epoch, the following operations are performed starting with 420. As the term is commonly used in the art, an “epoch” refers to the number of complete passes that are made by the machine learning engine (e.g., a neural network) through a training dataset. An epoch is a hyperparameter that is set as an integer value between one and infinity.

In 420, replay buffers (herein referred to as buffers) are initialized for each parameterized option. A replay buffer is a known mechanism for saving data comprising past state transitions during RL. In certain aspects, the data is comprised of a tuple comprised of initial state (S), an action (A) by the agent based upon initial state, a reward (R) based upon the action, and a subsequent state(S′)). In addition, the data for a particular parameterized option includes one or more values corresponding to one or more parameters θₒ of the parameterized option. This saved data can be subsequently be sampled and used to create training data. The sampling of small batches of tuples from the buffer is known as experience replay, which has the advantage of breaking harmful correlations as well as providing the ability to reuse individual tuples.

In 430, for a first or subsequent episode, a high-level plan is obtained from a planner using, for example, the planning domain discussed with regard to 404. The high-level plan includes the plurality of parameterized options.

In 440, a first/next parameterized option is selected from the plan, and the manner by which the first/next parameter option is selected form the plan is not limited as to a particular approach. Typically, an option is selected based upon the policy Πₙ for the particular MDP Mₙ being evaluated.

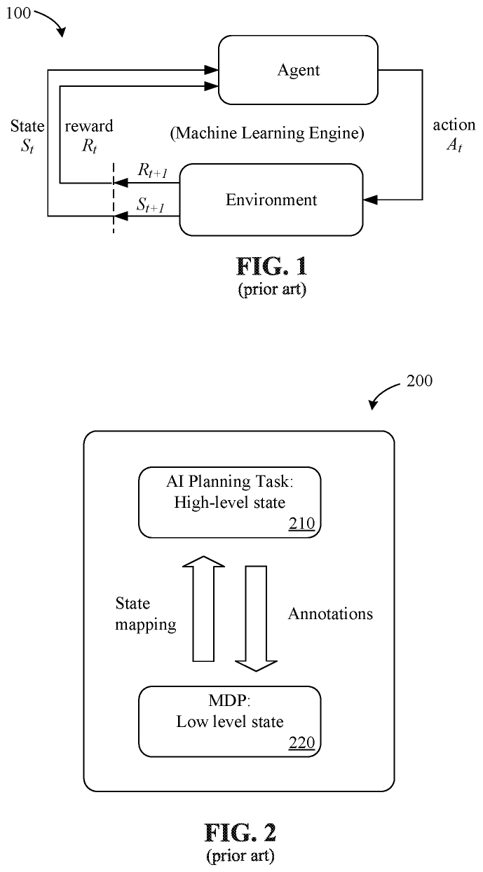

After the first/next parameterized option is selected, a reinforcement learning process is performed in 450. FIG. 4B further illustrates aspect of the reinforcement learning process, which is very similar to the reinforcement learning process discussed with regard to FIG. 1. In 451, based upon a current state S, the intra-option policy πₒ is consulted to obtain an action A. The action A is applied to the environment in 453. In 455 and 457, a reward R is obtained based upon a new state S′ as a result of the action A. In 459, the tuple of the current state S, action A, reward R, new state S′, and values of the one or more parameters θₒ are stored in the buffer for the particular parameterized option being trained. In 460, a determination is made whether the sub-goal of the parameterized option is achieved or a predefined number of steps have been performed. If not the reinforcement learning process 450 is repeated. Otherwise, the process 400 proceeds to 470.

In 470, a determination is made whether the goal of the policy 1I has been achieved (i.e., an episode has been completed) or a maximum number of interactions/steps have been performed. If the episode has not been completed, the process 400 proceeds to 440 in which another parameterized option is identified from the high-level plan. Other, the process proceeds to 480.

In 480, the intra-option policies are updated using the data contained with the buffers. There are a number of known RL algorithms capable of training a policy using the data in the buffers, and the present disclosure is not limited as to a particular RL algorithm so capable.

In 490, a determination is made whether to perform another epoch. In this instance, the process 400 is not limited as to the number of epochs being performed. Once the number of desired epochs have been achieved, the process 400 ends at 495.

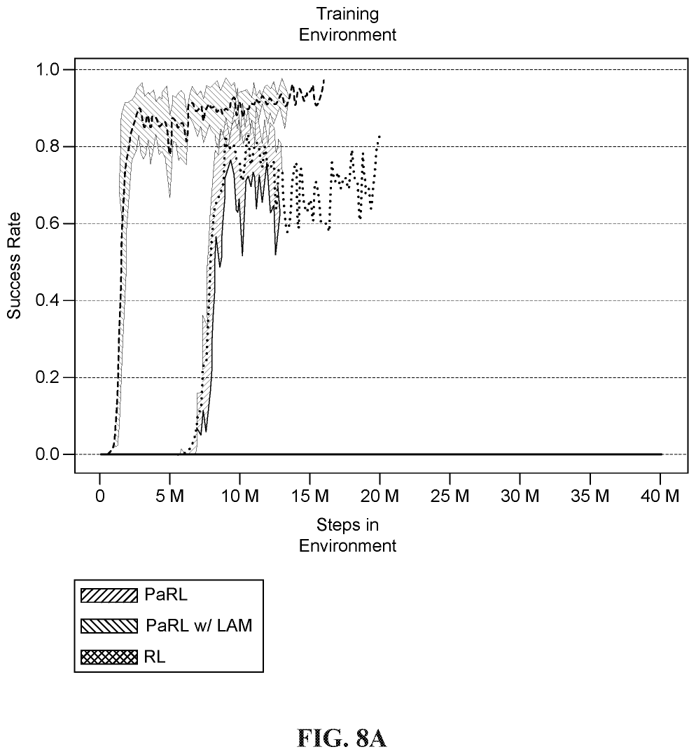

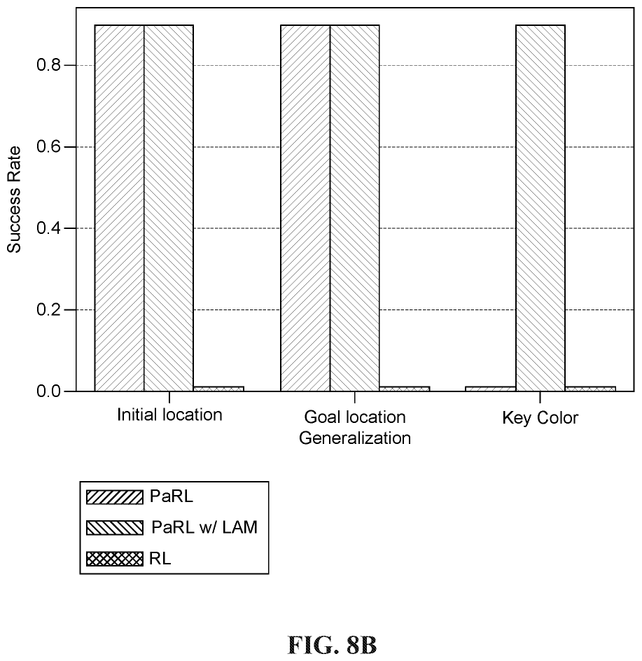

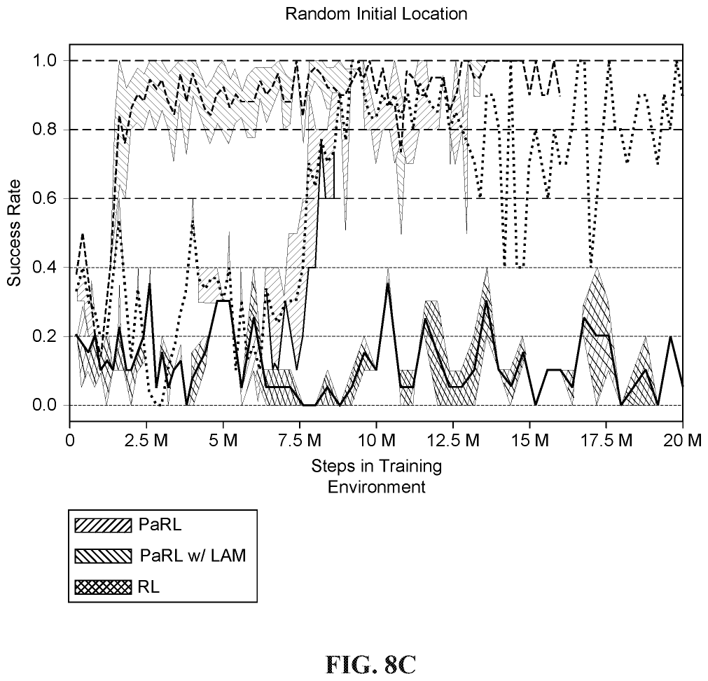

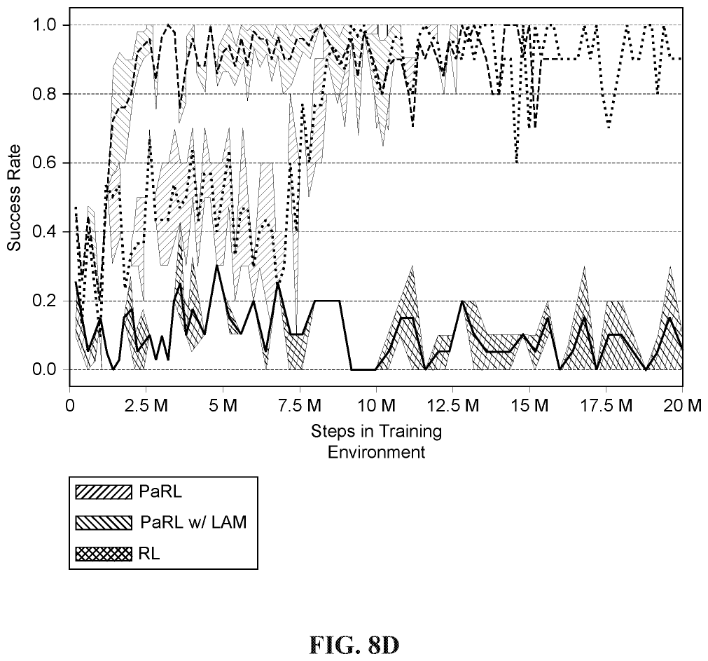

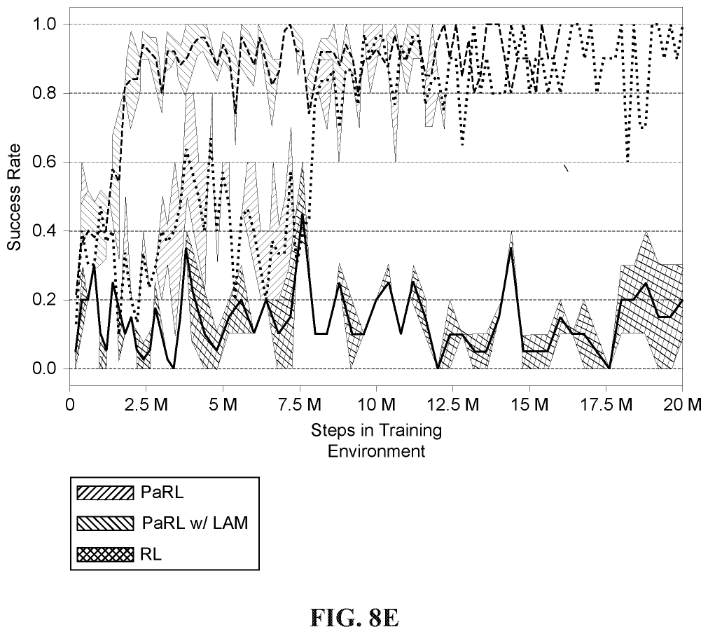

FIGS. 8A-E illustrate comparative results from using PaRL, using modified PaRL according to the aspects of the disclosed invention (e.g., using LAM), and using standard RL. The values in these charts were generated using a Proximal Policy Optimization (PPO) trainer from RLLib, which is an open-source library for implementing RL. FIG. 8A illustrates a comparison of a success rate achieved by the disclosed modified PaRL approach with that of standard RL. In particular, the plot illustrates the efficiency of lifted PaRL over baselines in a training environment. FIG. 8B illustrates a comparison of a success rate achieved the three approaches trained on new MDPs. In the first set of bar plots, the initial location was randomly sampled. In the second set, the goal location was randomly sampled. In the third set, the locations were the same as the training environment but the key color was randomly sampled. Overall, FIG. 8B demonstrates the generalization capability of different agents. FIG. 8C illustrates sample efficiency of the lifted PaRL for generalization, which indicates that the lifted PaRL approach requires significantly less number of steps in the environment to successfully generalize to a random initial location. FIG. 8D illustrates sample efficiency for generalization to a random initial location and goal location. FIG. 8E illustrates sample efficiency for generalization to a random goal location.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

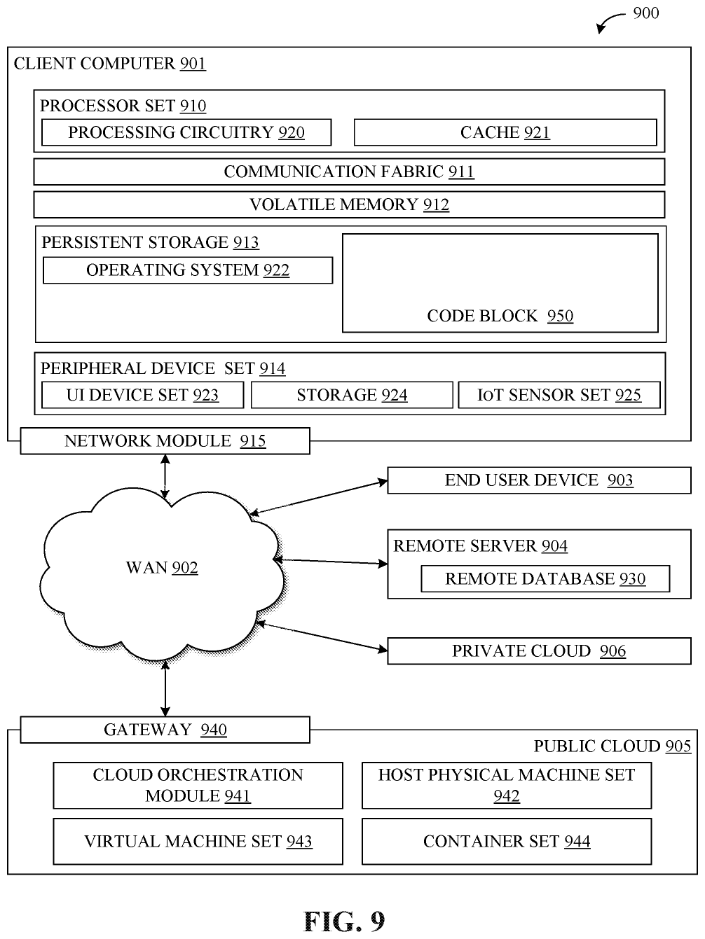

Referring to FIG. 9, computing environment 900 contains an example of an environment for the execution of at least some of the computer code involved in performing the inventive methods, such as code block 950 for reinforcement learning. Computing environment 900 includes, for example, computer 901, wide area network (WAN) 902, end user device (EUD) 903, remote server 904, public cloud 905, and private cloud 906. In certain aspects, computer 901 includes processor set 910 (including processing circuitry 920 and cache 921), communication fabric 911, volatile memory 912, persistent storage 913 (including operating system 922 and method code block 950), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

Computer 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. However, to simplify this presentation of computing environment 900, detailed discussion is focused on a single computer, specifically computer 901. Computer 901 may or may not be located in a cloud, even though it is not shown in a cloud in FIG. 9 except to any extent as may be affirmatively indicated.

Processor set 910 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In certain computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in code block 950 in persistent storage 913.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 911 is the signal conduction paths that allow the various components of computer 901 to communicate with each other. Typically, this communication fabric 911 is made of switches and electrically conductive paths, such as the switches and electrically conductive paths that make up busses, bridges, physical input/output ports and the like. Other types of signal communication paths may be used for the communication fabric 911, such as fiber optic communication paths and/or wireless communication paths.

Volatile memory 912 is any type of volatile memory now known or to be developed in the future. Examples include dynamic type random access memory (RAM) or static type RAM. Typically, the volatile memory 912 is characterized by random access, but this is not required unless affirmatively indicated. In computer 901, the volatile memory 912 is located in a single package and is internal to computer 901. In addition to alternatively, the volatile memory 912 may be distributed over multiple packages and/or located externally with respect to computer 901.

Persistent storage 913 is any form of non-volatile storage for computers that is now known or to be developed in the future. The non-volatility of the persistent storage 913 means that the stored data is maintained regardless of whether power is being supplied to computer 901 and/or directly to persistent storage 913. Persistent storage 913 may be a read only memory (ROM), but typically at least a portion of the persistent storage 913 allows writing of data, deletion of data and re-writing of data. Some familiar forms of persistent storage 913 include magnetic disks and solid state storage devices. Operating system 922 may take several forms, such as various known proprietary operating systems or open source Portable Operating System Interface type operating systems that employ a kernel. The code included in code block 950 typically includes at least some of the computer code involved in performing the inventive methods.

Peripheral device set 914 includes the set of peripheral devices for computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some aspects, storage 924 may take the form of a quantum computing storage device for storing data in the form of qubits. In aspects where computer 901 is required to have a large amount of storage (for example, where computer 901 locally stores and manages a large database) then this storage 924 may be provided by peripheral storage devices designed for storing very large amounts of data, such as a storage area network (SAN) that is shared by multiple, geographically distributed computers. Internet-of-Things (IoT) sensor set 925 is made up of sensors that can be used in IoT applications. For example, one sensor may be a thermometer and another sensor may be a motion detector.

Network module 915 is the collection of computer software, hardware, and firmware that allows computer 901 to communicate with other computers through a Wide Area Network (WAN) 902. Network module 915 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 915 are performed on the same physical hardware device. In other aspects (for example, aspects that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any Wide Area Network (for example, the internet) capable of communicating computer data over non-local distances by any technology for communicating computer data, now known or to be developed in the future. In some aspects, the WAN 902 ay be replaced and/or supplemented by local area networks (LANs) designed to communicate data between devices located in a local area, such as a Wi-Fi network. The WAN 902 and/or LANs typically include computer hardware such as copper transmission cables, optical transmission fibers, wireless transmission, routers, firewalls, switches, gateway computers and edge servers.

End user device (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In certain aspects, EUD 903 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904. As defined herein, the term “server” means a data processing system configured to share services with one or more other data processing systems.

Public cloud 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 906 is similar to public cloud 905, except that the computing resources are only available for use by a single enterprise. While private cloud 906 is depicted as being in communication with WAN 902, in other aspects, a private cloud 906 may be disconnected from the internet entirely (e.g., WAN 902) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 905 and private cloud 906 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A computer-implemented method for generating a policy for performing a goal and including a plurality of intra-option policies, comprising:
receiving a planning domain including lifted action models;
receiving a Markov Decision Process (MDP) distribution;
generating a mapping function between MDP states of a MDP within the MDP distribution and planning states of the planning domain;
defining, using the mapping function, a parameterized option for each of the lifted action models;
training, using reinforcement learning, an intra-option policy for each of the parameterized options.

2. The method of claim 1, wherein
a particular one of the parameterized options is defined as:
an initiation set for the particular one of the parameterized options,
one or more option parameters,
a termination condition for the particular one of the parameterized options, and
an intra-option policy for the particular one of the parameterized options.

3. The method of claim 2, further comprising:
initializing a replay buffer for the particular one of the parameterized options, wherein
the training for the particular one of the parameter options includes storing, within the replay buffer and for a particular action from the intra-option policy for the particular one of the parameterized options, data including:
an initial state,
the particular action,
a reward,
a subsequent state, and
one or more values associated with the one or more option parameters, and
the intra-option policy for the particular one of the parameterized options is updated using the data.

4. The method of claim 1, wherein
the MDP distribution defines an environment including a plurality of MDP meeting constraints, and
the constraints including a predicate, action, object, type, and action model.

5. The method of claim 4, wherein
the policy for performing the goal is configured to be used with a second MDP that meets the constraints.

6. The method of claim 1, wherein
the mapping is generated using planning annotated reinforcement learning (PaRL).

7. The method of claim 1, wherein
the planning domain includes a plurality of options for performing the goal.

8. A computer hardware system for generating a policy for performing a goal and including a plurality of intra-option policies, comprising:
a hardware processor configured to perform the following executable operations:
receiving a planning domain including lifted action models;
receiving a Markov Decision Process (MDP) distribution;
generating a mapping function between MDP states of a MDP within the MDP distribution and planning states of the planning domain;
defining, using the mapping function, a parameterized option for each of the lifted action models;
training, using reinforcement learning, an intra-option policy for each of the parameterized options.

9. The system of claim 8, wherein
a particular one of the parameterized options is defined as:
an initiation set for the particular one of the parameterized options,
one or more option parameters,
a termination condition for the particular one of the parameterized options, and
an intra-option policy for the particular one of the parameterized options.

10. The system of claim 9, wherein the hardware processor is further configured to perform:
initializing a replay buffer for the particular one of the parameterized options, wherein
the training for the particular one of the parameter options includes storing, within the replay buffer and for a particular action from the intra-option policy for the particular one of the parameterized options, data including:
an initial state,
the particular action,
a reward,
a subsequent state, and
one or more values associated with the one or more option parameters, and
the intra-option policy for the particular one of the parameterized options is updated using the data.

11. The system of claim 8, wherein
the MDP distribution defines an environment including a plurality of MDP meeting constraints, and
the constraints including a predicate, action, object, type, and action model.

12. The system of claim 11, wherein
the policy for performing the goal is configured to be used with a second MDP that meets the constraints.

13. The system of claim 8, wherein
the mapping is generated using planning annotated reinforcement learning (PaRL).

14. The system of claim 8, wherein
the planning domain includes a plurality of options for performing the goal.

15. A computer program product, comprising:
a computer readable storage medium having stored therein program code for generating a policy for performing a goal and including a plurality of intra-option policies,
the program code, which when executed by a computer hardware system, causes the computer hardware system to perform:
receiving a planning domain including lifted action models;
receiving a Markov Decision Process (MDP) distribution;
generating a mapping function between MDP states of a MDP within the MDP distribution and planning states of the planning domain;
defining, using the mapping function, a parameterized option for each of the lifted action models;
training, using reinforcement learning, an intra-option policy for each of the parameterized options.

16. The computer program product of claim 15, wherein
a particular one of the parameterized options is defined as:
an initiation set for the particular one of the parameterized options,
one or more option parameters,
a termination condition for the particular one of the parameterized options, and
an intra-option policy for the particular one of the parameterized options.

17. The computer program product of claim 16, wherein the computer hardware processor is further configured to perform:
initializing a replay buffer for the particular one of the parameterized options, wherein
the training for the particular one of the parameter options includes storing, within the replay buffer and for a particular action from the intra-option policy for the particular one of the parameterized options, data including:
an initial state,
the particular action,
a reward,
a subsequent state, and
one or more values associated with the one or more option parameters, and
the intra-option policy for the particular one of the parameterized options is updated using the data.

18. The computer program product of claim 15, wherein
the MDP distribution defines an environment including a plurality of MDP meeting constraints, and
the constraints including a predicate, action, object, type, and action model.

19. The computer program product of claim 18, wherein
the policy for performing the goal is configured to be used with a second MDP that meets the constraints.

20. The computer program product of claim 15, wherein
the mapping is generated using planning annotated reinforcement learning (PaRL).
